(19) United States
(12) Patent Application Publication
(10) Pub. No.: US 2018/0055270 A1
(43) Pub. Date: Mar. 1, 2018

(54) COOKING APPARATUSES, LABELING SYSTEMS, METHODS FOR SOUS VIDE COOKING

(71) Applicant: ModernChef, Inc., Seattle, WA (US)

(72) Inventors: Scott Martin Heimendinger, Seattle, WA (US); Lukas Svec, Seattle, WA (US)

(21) Appl. No.: 15/695,758

(22) Filed: Sep. 5, 2017

Related U.S. Application Data
(63) Continuation of application No. PCT/US16/21063, filed on Mar. 4, 2016.
(60) Provisional application No. 62/129,649, filed on Mar. 6, 2015.

(51) Int. Cl. A47J 27/10; A23L 5/10

(52) U.S. Cl. CPC A47J 27/10; A23V 2002/00; A23L 5/10

(57) ABSTRACT

Methods, apparatus, and systems for providing information available during the packaging process for a food to be available during the cooking process for the food.

### CROSS-REFERENCE TO RELATED APPLICATIONS

This application is a continuation of International Application No. PCT/US2016/021063 entitled COOKING APPARATUSES, LABELING SYSTEMS, AND METHODS FOR SOUS VIDE COOKING, filed Mar. 4, 2016, which claims the benefit of U.S. Provisional Patent Application No. 62/129,649, entitled COOKING APPARATUSES AND LABELING SYSTEMS FOR SOUS VIDE COOKING, filed Mar. 6, 2015, both of which applications are incorporated herein by reference in their entireties.

### TECHNICAL FIELD

The present disclosure relates generally to cooking apparatuses, labeling systems, and methods for heating food.

### BACKGROUND

Sous vide is a cooking method that involves precise temperature control to cook food to a specific doneness. Conventional sous vide machines (e.g., immersion circulators) often maintain a temperature-controlled water bath at a target temperature. A sealed pouch containing food is submerged in the bath, and the pouch prevents contact between the water bath and food while the bath heats the food to the target temperature. In commercial environments, food is often packaged in vacuum-sealed, food-safe plastic pouches. In home environments, food is often placed in bags (e.g., zip bags, Ziploc® bags, or other food storage bags) with most of the air removed, or in some other container that allows heat to transfer from water baths to food. In some sous vide techniques, food can be cooked in an oven, often approaching 100% relative humidity, and may or may not be packaged in sealed bags.

Food can be cooked according to a set of well-known temperatures at which the food is considered desirable. By way of example, a beef steak may be considered “rare” at 50° C., “medium rare” at 55° C., etc. Specific desirable temperatures vary between different foods, but typically range between 45° C. (e.g., for delicate fish) to 85° C. (e.g., for tough vegetables). A piece of food should be left in the heated water bath for a sufficient length of time (i.e., cooking time) to allow the entire piece of food to reach the target temperature. Cook times for interior regions (e.g., core or middle regions) of sealed pieces of food to reach the desired temperature depend on the dimensions of each piece of food. For example, the cooking time scales roughly with the square of the thickness of the piece of food and is also influenced by the desired doneness temperature. This time represents the minimum sous vide cooking time.

The minimum cooking time can be extended to, for example, pasteurize food. When cooking poultry, additional time can be added to the cooking time to pasteurize the poultry. When cooking tough cuts of meat (e.g., ribs, brisket, etc.), additional cooking time allows the tough connective tissue to gelatinize, yielding more tender results. The additional cooking times may vary from 20 minutes for pasteurization to 72 hours for tenderizing tough cuts.

Due to relatively large variances in target temperatures and cooking times, it can be challenging to determine how to cook sous vide to achieve a desired doneness. Chefs and cooks often use rule of thumb estimates, which lead to non-optimal results.

### SUMMARY OF TECHNOLOGY

One or more embodiments of the technology is a system that provides information associated with packaging processes for pieces of food such that the information can be used to determine cooking processes for the pieces of food. In some embodiments, a cooking time and a target temperature can be set without consulting reference information. In some embodiments, the cooking time and target temperature can be set for a cooking apparatus without having a user (e.g., chef, cook, etc.) interact with a controller of the cooking apparatus. Historical preferences (e.g., a user's preference, multiple users' preferences, etc.) can be used to determine (e.g., calculate, select, etc.) recommended cooking specifications/protocols. The system can store and access data for food that was prepared and/or consumed to evaluate nutrition, track money spent, generate a historical log (e.g., a log of food prepared and/or consumed), and/or track the attributes of the food.

One or more embodiments of the technology are a computer-based system that includes memory and a programmable processor. The programmable processor can include circuitry configured to execute instructions to cause the programmable processor to perform features of the technology, such as calculating cooking parameters based on stored recommended cooking parameters and sending (e.g., transmitting) the calculated cooking parameters to a cooking apparatus. The cooking apparatus can cook the food based on the calculated cooking parameters to achieve a target doneness throughout substantially all of the food. In some embodiments, the computer-based system includes a cooking apparatus with a controller. In some embodiments, the cooking apparatus and controller (e.g., a smartphone, a laptop computer, etc.) are separate components.

At least some embodiments are methods for determining one or more sous vide cooking parameters. Information (e.g., recommended cooking parameters, information about food to be cooked, etc.) can be associated with packaging for the food. In one embodiment, information is encoded onto the packaging. An electronic device can read the information and, in some embodiments, can cook the food based on the information. The information can be one or more of a target temperature, cooking time, etc., and can be stored for later use.

At least some embodiments are directed to methods for determining cooking times and temperatures for a piece of food. Cooking information associated with the piece of food can be read by, for example, an electronic cooking apparatus. The cooking information can include the type of food (e.g., meat, vegetables, etc.), cooking times, temperatures, and/or data suitable to determine instructions to cook the food. A water bath can be heated to a specified temperature and a timer can be set for a specified cooking time. The electronic cooking apparatus can automatically cook the food based on the cooking information. The cooking information can be provided by an indicator (e.g., a tag) associated with packaging for the piece of food.

In some embodiments, a method comprises reading information from an indicator (e.g., a tag) associated with food. A target temperature and/or a cooking time can be determined based on the information from the indicator. A cooking apparatus can cook the food based on the target temperature and/or the cooking time. In one embodiment, a controller of the cooking apparatus is automatically set to the target temperature, the cooking time (e.g., a minimum cooking time), and/or other cooking parameter(s). For example, the controller can automatically obtain information from the indicator and determine how to cook the food.

In yet further embodiments, a method comprises storing recommended sous vide cooking parameters and calculating cooking parameters based on the stored recommended sous vide cooking parameters. The calculated cooking parameters can be sent to a cooking apparatus, which cooks the food based on the calculated cooking parameters to achieve, for example, a target doneness (e.g., a target doneness throughout substantially all the food). In some embodiments, the method includes receiving cooking data from the cooking apparatus and storing the cooking data in a data structure, databases, meta data, and/or plain text having a data structure for storing readable data.

Some embodiments are a food labeling system that includes a measuring device configured to measure at least one metric of a piece of food, a computer, and a labeling apparatus. The computer is configured to determine at least one sous vide cooking parameter for cooking food based on measured metric, such as dimension(s) of the food. The labeling apparatus can label the food with machine-readable data and can include one or more printers, encoders (e.g., a read/write device for encoding RFID data), or other devices capable of applying indicators to packaging for food or food itself. In some embodiments, the labeling apparatus includes an applicator device capable of applying an indicator. For example, an indicator can be adhered to or incorporated into packaging for food.

In some embodiments, a cooking apparatus includes a controller and a device for receiving information from an indicator for a piece of food. The controller is in communication with the device and includes a programmable processor with circuitry configured to execute instructions to cause the programmable processor to determine a target temperature and/or a cooking time based on the information received by the device. In one embodiment, the cooking apparatus is an immersion circulator for sous vide cooking. The immersion circulator can provide precise temperature control to keep a bath at a target temperature (e.g., a target temperature ±1° C., ±2° C., or ±5° C.). In other embodiments, the cooking apparatus is an oven or a slow cooker.

In some embodiments, a method for heating food includes reading information from an indicator associated with food. An apparatus can read the information and can thermally process the food based on the information. For example, a cooking apparatus can read information from an indicator that is carried by or part of packaging for food. The cooking apparatus can then cook the food based on the information. The information can include, without limitation, one or more temperature settings, periods of time, or the like. The temperature settings can include cooking temperatures, hold temperatures, temperature profiles, and/or other temperature information. Cooking temperatures can be target temperatures for cooking food, and hold temperatures can be temperatures for keeping food warm without further cooking it. After an egg has or will reached its desired doneness, the temperature can be reduced to avoid or inhibit further cooking. The cooking apparatus can a cooling system for actively cooling the cooking environment. Cooling systems can include heat-exchangers or other components for transferring heat from the cooking environment (e.g., warm bath water) to the surrounding environment.

A cooking apparatus can determine an appropriate heating protocol to achieve desired doneness, hold the food at suitable hold temperature, reheat cooked food, cook partially cooked food, and/or otherwise thermally process food. In one embodiment, food packaging includes a tag that is read to obtain information about the food contained therein. Advantageously, the food packaging can hold the food before, during, and/or after cooking to avoid or minimize problems caused by handling the food. In other embodiments, food can be removed from the packaging and then placed in new packaging (e.g., packaging containing spices, marinades, etc.) before cooking. By way of another example, fully cooked food can be kept in the food packaging during a heating process. For example, frozen cooked food can be heated to a target serving temperature while the food is kept in packaging.

Some embodiments are cooking apparatuses capable of determining a heating schedule for sequentially or concurrently heating different types of food. The cooking apparatuses can determine, for example, a staged heating protocol for sous vide cooking individually packaged food. The cooking apparatus can determine target temperatures (e.g., cooking temperatures, hold temperatures, serving temperatures, etc.), heating periods, and other heating parameters. The cooking apparatus can inform a user when to remove, add, or otherwise handle the food. For example, the user can be informed by an alert (e.g., inaudible or visual alarm), a notification system (e.g., via text messaging, email, etc.), and/or a display of the cooking apparatus. In some embodiments, the cooking apparatus can send a cooking schedule to a user's electronic device, such as a smartphone or tablet. The electronic device can notify the user when to take action, such as adding or removing packages of food. The cooking apparatus can adjust operation based upon completion of the action.

The cooking apparatus can include a controller programmed to determine the staged heating protocol for different food items based on, for example, information from a plurality of indicators (e.g., where each indicator is associated with one of the food items) or a single indicator with information for all the food items. A staged heating protocol for sequentially cooking vegetables and meat can be different from a staged heating protocol for sequentially cooking multiple vegetable dishes or for sequentially heating different meats (e.g., pork, beef, lamp, fish, etc.). A staged heating protocol can require that each food item be left within the cooking environment throughout the remainder of the heating process. In other staged heating protocols, one or more the food items can be removed at various times in the heating process. In one staged protocol, tough vegetables are cooked at 85° C. The cooking environment (e.g., a heated water bath) is then cooled to 50° C. to cook beef steak. The partially or fully cooked vegetables can be left in the cooking environment while the beef steak is cooked.

In some embodiments, the controller is programmed to determine heating protocols based on user preference settings. These preference settings can include target doneness, overall cooking time, or other user preferences. In some embodiments, the controller is programmed to determine sous vide staged heating schedules with (1) one or more target temperatures for each package of food and/or (2) heating periods for each package of food. Each package of food can be heated in the same bath, and the temperature of the bath can be varied at any time in the heating process.

### BRIEF DESCRIPTION OF THE DRAWINGS

The same reference numerals refer to like parts or acts throughout the various views, unless otherwise specified.

FIG. 1 is a flow chart of a method of packaging and cooking food in accordance with embodiments of the disclosed technology.

FIG. 2 shows packaging in accordance with embodiments of the disclosed technology.

FIG. 3 shows interaction between elements of a system in accordance with embodiments of the disclosed technology.

FIG. 4 shows a cooking apparatus in accordance with embodiments of the technology.

### DETAILED DESCRIPTION OF TECHNOLOGY

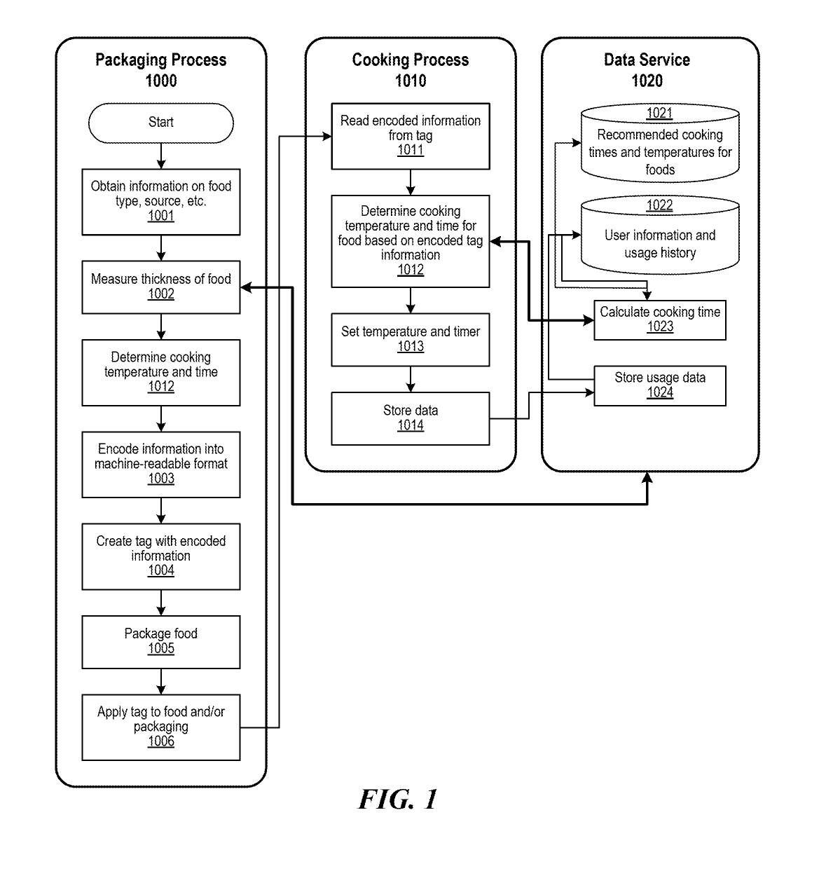

FIG. 1 is a flow chart of a method for packaging and cooking food in accordance with embodiments of the disclosed technology. Generally, cooking information for a piece of food can be obtained and used to determine cooking parameters for cooking the food sous vide. Packaging and/or the food itself can be labeled with the cooking information, cooking parameters, or other data. An electronic device can obtain the cooking information, cooking parameters, or other data and set a cooking temperature, cooking time, etc. Although exemplary embodiments described herein are directed to sous vide cooking, it will be appreciated that the technology can be used with other types of cooking apparatuses, such as slow cookers (e.g., crock pots), fryers, ovens, etc.

A packaging process (1000) may take place in a facility that packages meat commercially, such as a farm, a slaughterhouse, a butcher or a meat department of a grocery store. In other embodiments, the process (1000) may take place in a home kitchen. In yet other embodiments, the process (1000) takes place in a restaurant.

The process (1000) can begin by obtaining information about the food (1001). Examples of such information may include, but are not limited to, the type of food (e.g., cow, pig, artichoke, etc.), cut of meat (e.g., New York strip steak, loin, blossom, etc.), origin of the food (e.g., location, name, or other information about food source), diet of animals (e.g., corn-fed, grass feed, etc.), date of slaughter or harvest (e.g., May 5, 2014), processing information (e.g., aging information, such as days aged for meat), regulatory certifications (e.g., USDA Organic, kosher, hormone-free, etc.), unique item codes, food state information (e.g., information about whether the food is raw, partially cooked, fully cooked, etc.), or serial numbers, and/or other information. The information specified in (1001) may be unique to each piece or type of food to be packaged and may be supplied manually by an operator or obtained automatically via sensors.

The thickness of each piece of food can be measured by a measurement apparatus, such as a digital device (e.g., an optical sensor, an ultrasonic measurement apparatus, etc.) or a mechanical device (e.g., a caliper). In other embodiments, the measurement may be obtained from existing specifications or a lookup table. For example, the existing specification can be how thick to cut the food in a previous step. Other dimensions of the food can also be measured.

In some embodiments, information obtained at (1001) and (1002) is sent to a data service or system (1020) (“data service (1020)”) that calculates information (1023) including, but not limited to, recommended cooking instructions. Data returned from the data service (1020) may be presented in a desired format on an indicator created at (1004). The desired format can be a human-readable and/or machine-readable format.

The information from (1001) and (1002) can be encoded into machine-readable format (1003). Machine-readable format can be, without limitation, radio frequency identification (RFID) indicator format, QR code, barcode, or other optically, magnetically, or frequency-based machine-readable code.

An indicator can be created with the encoded information from (1003). In one embodiment, the indicator may be a physical sticker with encoded information (1003), such as a barcode or a QR code. Alternatively, the indicator may be an RFID indicator, or another device or mechanism that can be addressed through radio frequency communication.

At (1005), the food is packaged. The packaging can be a food-safe plastic bag into which the food is placed and then sealed under vacuum to remove air from the interior of the bag. In other embodiments, the packaging may be a paper or foam tray wrapped in plastic wrap. The configuration and material of the packaging can be selected based on the characteristics of the food and how the food is to be stored.

The indicator can be applied (1006) to the exterior of the food packaging. The indicator can be a sticker, label, or the like. In other embodiments, the indicator (e.g., an RFID indicator, tag, etc.) can be embedded or part of the packaging. In yet other embodiments, the indicator may be attached or embedded in the food itself. For example, the indicator may be in the form of a small RFID indicator, which is safe to consume, can be attached to the food. Alternatively or additionally, information (1003) may be transferred onto the surface of the food by stamping or etching. The stamping or etching can serve as an indicator.

After the packaging process (1000) is complete, the packaged food may be stored locally and/or remotely until the cooking process (1010) is ready. The cooking process (1010) can generally include obtaining information from the indicator, determining cooking parameters based on the obtained information, and controlling a cooking apparatus based on the obtained information and/or cooking parameters. The cooking parameters can include, for example, cooking profiles, cooking times, cooking temperatures (or temperature ranges), instructions, and/or other information useful for sous vide. Data generated during cooking can be stored by the cooking apparatus and/or on another device. Details of the cooking process (1010) are discussed in detail below.

When using a sous vide water bath, preparing the cooking environment may include adding water to a basin or suitable container. When using a cooking apparatus in the form of a steam oven, the preparation process may include turning on the steam oven and arranging cooking racks as desired. In embodiments in which the indicator (1004) has optically encoded information, the indicator may be scanned using an electronic device, such as a reader (e.g., a camera or other optical scanner). In other embodiments, the indicator may be read via near field radio frequency communication using an RFID reader of the cooking apparatus. The read operation (1011) can occur for each piece of food placed in the vicinity of the reader.

In some embodiments, the reader may be a separate device from the cooking apparatus. For example, a mobile phone or hand-held scanner can serve as a reader for reading the indicator information (1011) and can communicate with the cooking apparatus and/or the data service (1020). In some embodiments, a computing device can read the indicator and can then send information to the cooking apparatus via a wired connection, a wireless connection, or other suitable connection. The computing device can be, for example, a smartphone, a tablet, a computer, and/or other suitable device and can determine cooking parameters and send the cooking parameters to the cooking apparatus. In other embodiments, the computing device sends information to the cooking apparatus, and the cooking apparatus can determine cooking parameters based on the transmitted information.

Once the indicator information has been read, the system can determine cooking temperature(s) (e.g., a target temperature, a target temperature range, a temperature profile, etc.), cooking times (1012) for food(s) specified in (1011), and/or other cooking parameters. The determination can be made by communicating with the external data service (1020). In other embodiments, components of the data service (1020) are replicated locally in the cooking apparatus and/or an external device (e.g., a computer, a server, a mobile phone, a tablet, etc.) in communication with the cooking apparatus.

The cooking parameters can be calculated (1023) based on predetermined recommended cooking times and temperatures (1021), user information, and/or usage history. The user information can correspond to the user of the system (1022) or a group of users. For example, predetermined recommended cooking temperature for a New York strip steak may be 55° C. (±1° C.), but the user's historical preferences may indicate that the user prefers a lower doneness temperature. As such, the calculated cooking time and temperature can account for the user's lower temperature preference. Additionally, the calculation (1023) may take into account historical data from a plurality of users to adjust the predetermined recommendations. In some embodiments, the state of the food can be used to determine an appropriate heating routine. The state of the food can indicate whether the food is frozen, uncooked (e.g., raw), partially cooked, fully cooked, processed for food safety (e.g., cured, pasteurized, flash frozen, etc.), and/or the like. Frozen food can be heated for a longer period to firm to thaw and then cook the food. Uncooked food can be cooked for longer periods of time than partially or fully cooked food. Cooking, reheating, and/or thawing times can be selected based on whether the food has been processed for food safety.

The recommended cooking time and temperature calculated at (1023) can be sent to the cooking apparatus or reader device as a set of values. At (1013), a cooking apparatus can be instructed to set the cooking environment temperature heaters, and/or applicable timers to such values. The user may optionally override the recommended values.

Data collected at the beginning, during, and/or at the completion of the cooking process can be stored (1014) for access by the data service (1012). For example, the data can be available to the data service to determine future recommendations.

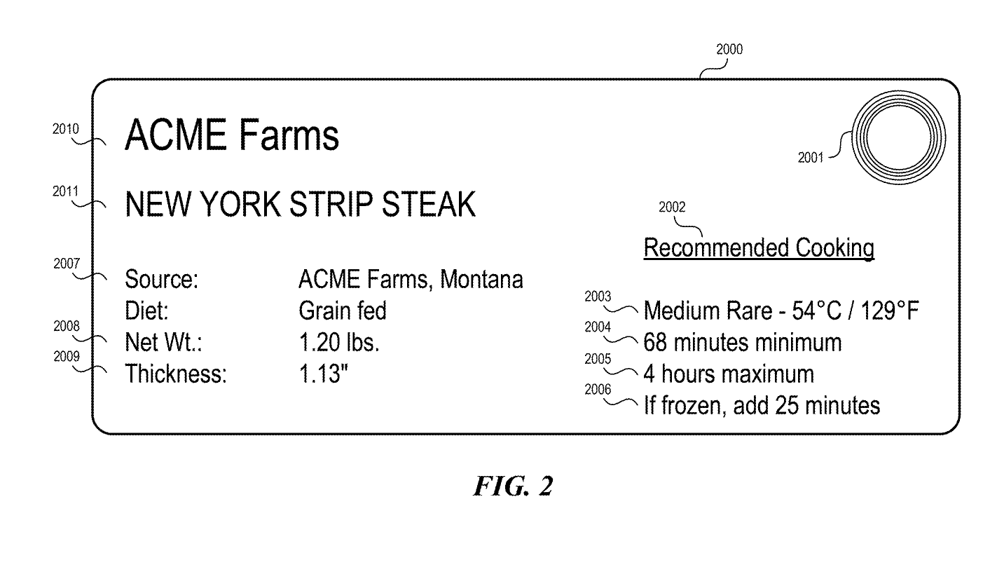

FIG. 2 shows packaging in accordance with embodiments of the disclosed technology. An indicator (2000) can include human-readable information and/or machine-readable information. In some embodiments, machine-readable information may be encoded in an RFID indicator (2001). Alternately, the information may be encoded into an optically readable indicator, such as a barcode, QR code, or the like.

In some embodiments, the indicator may show human-readable information derived in (1012) of FIG. 1. This information may include recommended cooking instructions (2002). Example embodiments of these instructions may include one or more of:
cooking temperature (2003),
minimum cooking time (2004),
maximum cooking time (2005),
additional cooking time if cooking from frozen (2006), and/or
other data calculated or derived from the attributes of the food.

The indicator (2000) may also include additional information about the food that may be relevant to the user's preferences with regard to sourcing, nutrition, and/or other factors that may influence the user's purchasing, cooking, and/or eating behavior. Example information may include one or more of:
identification of the producer, packager, and/or processor of the food (2007),
weight of the food (2008), and/or
thickness of the food (2009) measured in (1002) of FIG. 1.

The indicator (2000) may be applied to the packaging or directly to or within the food itself. In some embodiments, the indicator (2000) is adhered to packaging. In other embodiments, the indicator (2000) is part of the packaging. In some embodiments, the indicator (2000) can provide information for a plurality of individually packaged food items. The indicator (2000) can include information for multiple pouches, each containing different food items. The information can be obtained and used to individually or collectively heat the pouches.

The cooking apparatuses can perform staged cooking by determining a protocol or schedule for heating food sequentially or concurrently. A single cooking apparatus can cook a wide range of different types of foods using, for example, the same cooking environment, such as a water bath. By way of example, a pouch containing vegetables can be heated to a first temperature for a first period of time. The cooking apparatus can then adjust the cooking temperature to cook meat at a lower temperature while the vegetables remain in the cooking environment. The low temperature can be suitable for keeping the vegetables warm without overcooking them. The temperature of the cooking environment can be adjusted for each additional food item added to the environment.

Cooking apparatuses can determine cooking temperatures, cooking sequences (for example, sequence of cooking food items), user instructions, cooking periods, and other cooking parameters so that a single cooking apparatus can prepare a meal. In other embodiments, the indicator (2000) can contain the cooking protocol that is read and then execute by cooking apparatus. The cooking protocol can include cooking temperatures, cooking times, holding temperatures, holding times, sequence for cooking food, user instructions, or the like. The cooking apparatus can notify a user via an alarm (e.g., an audible alarm, a visual alarm, etc.), electronic notification (e.g., via text messaging, email, etc.), or other suitable means for notification.

Multiple cooking apparatuses can communicate with one another to prepare various food items. One of the cooking apparatuses can read information from indicators and can determine which cooking apparatuses should cook which food items. Additionally, the cooking apparatuses can indicate to a user when to place food items in each heating environment, remove food items from each heating environment, or the like. Alternatively, an application on an electronic device can control multiple cooking apparatuses to prepare food.

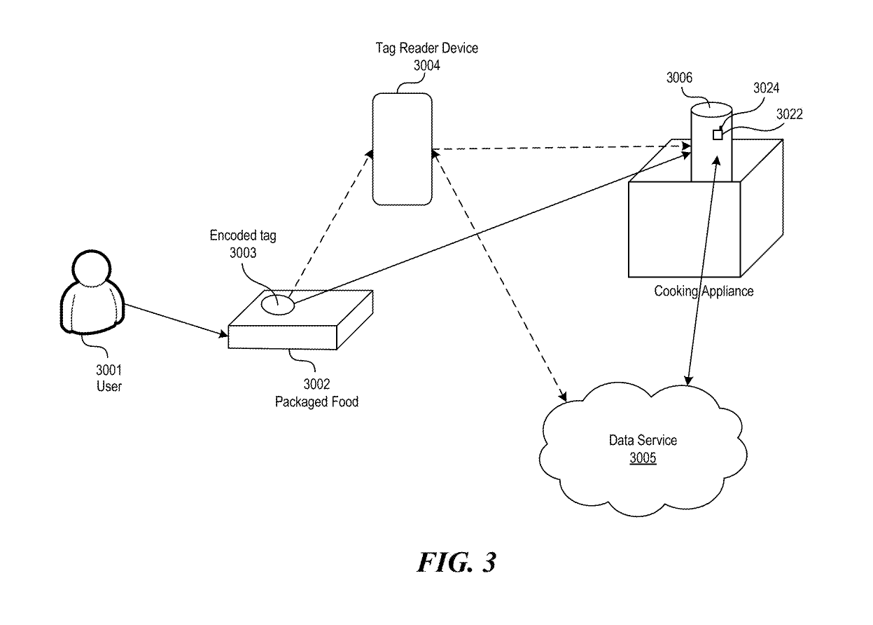

FIG. 3 shows interaction between elements of a system in which a user (3001) scans an indicator (3003) of packaged food (3002) using a separate electronic device in the form of an indicator reader device (3004) or the cooking apparatus (3006), etc. The reader device (3004) and/or cooking apparatus (3006) can communicate with a data service (3005) to retrieve information about the cooking specifications for the food (3002). The data service (3005) may be a remote service, or may be integral to the cooking apparatus (3006) or the indicator reader device (3004).

The cooking apparatus (3006), in various embodiments, can be an immersion circulator located in a container for holding a liquid (e.g., water) bath and can include an electronic device (3022) (e.g., a reader device) for receiving information associated with the food. The cooking apparatus (3006) can control the temperature of water, for example, and can continuously or periodically circulate the water. The device (3022) can include a communication element device (3024) configured to communicate with the reader device (3004) or another remote device. The communication element (3024) can include memory and one or more antennas and/or processor units. In some embodiments, the device (3022) is one or more of a reader in the form of a barcode reader, an RFID reader, an optical reader, or a camera.

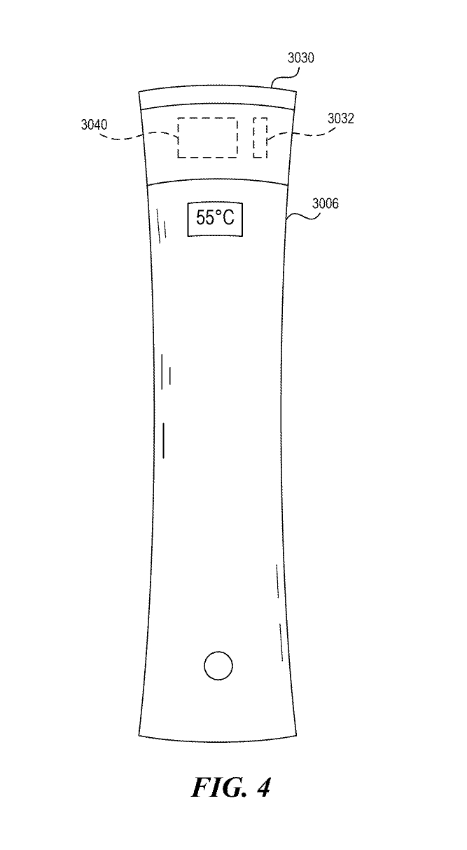

FIG. 4 shows a cooking apparatus (3006) in accordance with embodiments of the technology. The apparatus (3006) can include a controller (3030) with memory (3032) (shown in dashed line) for storing data and a programmable processor (3040) with circuitry configured to execute instructions. The stored data can include executable instructions, cooking parameters, usage history, user preferences, and/or other data used to control operation of the cooking apparatus (3006). The cooking parameters can include parameters inputted into the cooking apparatus (3006) by the user, parameters from the data service (3005) of FIG. 3, and/or parameters from another source.

The controller (3030) can be a computing device that controls operation of the cooking apparatus (3006) based on, for example, a target temperature and/or a target cooking time. The target temperature can correspond to a target doneness (e.g., rare, medium-rare, medium, medium-well, well, etc.). The cooking time can correspond to a minimum cooking time for cooking the food at the cooking temperature to achieve the target doneness throughout most or substantially all the piece of food. In some embodiments, the controller (3030) can control the cooking apparatus (3006) based on a stored or generated protocol.

The memory (3032) can be secure memory, standard memory, or a combination of both memory types. In various embodiments, the memory (3032) can be flash memory, secure serial EEPROM, secure field programmable gate array, or secure application-specific integrated circuit and can store instructions and computer programs. Computer programs can be written in any form of programming language and can be stored in a portion of a file that holds other programs or data (e.g., one or more scripts stored in a markup language document), in a single file dedicated to the program in question, or in multiple coordinated files (e.g., files that store one or more modules, subprograms, or portions of code).

The term “programmable processor” encompasses all kinds of apparatuses, devices, and machines for processing data, including by way of example a programmable microprocessor, a computer, a system on a chip, or multiple ones, or combinations of the foregoing. The programmable processor (3040) can include circuitry, special purpose logic circuitry, e.g., an FPGA (field programmable gate array) or an ASIC (application-specific integrated circuit). The programmable processor (3040) also can include, in addition to hardware, code that creates an execution environment for the computer program in question, e.g., code that constitutes processor firmware, a protocol stack, a database management system, an operating system, or a combination of one or more of them.

The components of systems disclosed herein can be interconnected by any form or medium of digital data communication, e.g., a communication network. For example, the cooking apparatus (3006) of FIG. 3 can be in communication a computing device (e.g., computer) of the reader (3004) of FIG. 3 and/or data service (3005) of FIG. 3 by a communication network. Examples of communication networks include a local area network (“LAN”) and a wide area network (“WAN”), an inter-network (e.g., the Internet), and peer-to-peer networks (e.g., ad hoc peer-to-peer networks).

Various embodiments of the technology are described above. Although some embodiments may be within the scope of the technology, they may not be described in detail with respect to FIGS. 1-4. Furthermore, features, structures, or characteristics of various embodiments may be combined in any suitable manner. Moreover, one skilled in the art will recognize that there are a number of other technologies that could be used to perform functions similar to those described above. While processes or acts are presented in a given order, the process or acts can be performed in different orders. In process (1000) of FIG. 1, for example, an indicator can be created (1004) after packaging the food (1005). Additionally, some processes or acts may be deleted, added, subdivided, combined, and/or modified.

Unless the context clearly requires otherwise, words using the singular or plural number also include the plural or singular number, respectively. Use of the word “or” in reference to a list of two or more items covers all of the following interpretations of the word: any of the items in the list, all of the items in the list, and any combination of the items in the list. Furthermore, the phrase “at least one of A, B, and C, etc.” is intended in the sense one having skill in the art would understand the convention (e.g., “a system having at least one of A, B, and C” includes but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

Aspects of the described technology can be modified, if necessary, to employ the systems, functions, and concepts of the various references described above to provide yet further embodiments. While the above details certain embodiments and describes the best mode contemplated, no matter how detailed, various changes can be made. Implementation details may vary considerably, while still being encompassed by the technology disclosed herein. Particular terminology used when describing certain features or aspects of the technology should not be taken to imply that the terminology is being redefined herein to be restricted to any specific characteristics, features, or aspects of the technology with which that terminology is associated.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A computer-implemented method for labeling food for sous vide cooking, comprising:
receiving information about the food;
determining, via a computer, at least one sous vide cooking parameter for cooking the food based on at least one metric of the food and the received information; and
labeling the food with at least one sous vide cooking parameter.

2. The computer-implemented method of claim 1, further comprising determining, via a measuring device, the metric which includes at least one dimension of the food.

3. The computer-implemented method of claim 1, wherein the received information includes one or more of food type, source of the food, and/or characteristics of the food.

4. The computer-implemented method of claim 1, wherein receiving the information includes obtaining the information from a database.

5. The computer-implemented method of claim 1, wherein receiving the information includes inputting information into an electronic device.

6. The computer-implemented method of claim 1, further comprising determining dimensional information of the food.

7. (canceled)

8. (canceled)

9. The computer-implemented method of claim 1, wherein at least one sous vide cooking parameter includes a cooking temperature corresponding to a target doneness and a cooking time for cooking the food at the cooking temperature to achieve the target doneness throughout substantially all the food.

10. The computer-implemented method of claim 1, wherein labeling the food includes applying machine-readable data to packaging for the food.

11. The computer-implemented method of claim 1, wherein labeling the food includes coupling an indicator having machine-readable data to a food package.

12. The computer-implemented method of claim 13, wherein coupling the indicator to the packaging includes adhering the indicator to the food packaging.

13. (canceled)

14. (canceled)

15. A system for labeling food, comprising:
a measuring device configured to measure at least one dimension of a piece of food;
a processor configured to execute instructions to determine at least one sous vide cooking parameter for cooking the piece of food based on the measured dimension and information about the piece of food; and
a labeling device for labeling the piece of food with machine-readable data corresponding to at least one sous vide cooking parameter.

16. The system of claim 15, wherein the measuring device is configured to measure the thickness of the piece of food.

17-20. (canceled)

21. The computer-implemented method of claim 19, further comprising heating a bath using the cooking apparatus that has been configured to the target temperature such that the food reaches a target doneness when the food has been cooked in the bath for the cooking time.

22. The computer-implemented method of claim 19, wherein reading the information from the indicator includes reading encoded information from the indicator via the cooking apparatus.

23. The computer-implemented method of claim 19, wherein determining the target temperature or the cooking time includes:
receiving a target doneness for the food, and
determining, via the computing device, both the target temperature and the cooking time based on the target doneness.

24. The computer-implemented method of claim 19, wherein determining the target temperature or the cooking time includes calculating the target temperature or the cooking time based on stored recommendations.

25. The computer-implemented method of claim 19, wherein determining the target temperature or the cooking time includes calculating the target temperature or the cooking time based on user information or usage history of the cooking apparatus.

26. The computer-implemented method of claim 19, further comprising storing usage data accessible to the cooking apparatus.

27. The computer-implemented method of claim 19, wherein the indicator is a first indicator and the food is a first food item, the method further comprising:
reading information, via the computing device, from a second indicator associated with a second food item;
determining, via the computing device, a second target temperature and/or a second cooking time based on the information from the second indicator; and
configuring the cooking apparatus with the second target temperature and/or the second cooking time for sous vide cooking the second food item.

28. A method for preparing food, the method comprising:
reading information, via an electronic device, from one or more indicators associated with a plurality of food items; and
determining, via a computing device, a cooking routine for each food item based upon the information such that a sous vide cooking apparatus cooks each food item according to a respective one of the cooking routines.

29. The method of claim 30, wherein reading the information includes sequentially reading information for each food item.

30-32. (canceled)

33. The cooking apparatus of claim 31, wherein the programmable processor determines both the target temperature and the cooking time, and wherein the target temperature corresponds to a target doneness and the cooking time corresponds to a minimum cooking time for cooking the food at the cooking temperature to achieve the target doneness across a thickness of the food.

34. (canceled)

35. The cooking apparatus of claim 31, wherein the device includes a communication device that communicates with a remote reader capable of reading the indicator.

36. The cooking apparatus of claim 31, wherein the cooking apparatus is an immersion circulator.

37. The cooking apparatus of claim 31, wherein the device is configured to receive cooking parameters via a network.

38. The cooking apparatus of claim 31, wherein the controller is programmed to determine a staged heating protocol for heating individually packaged food.

39. The cooking apparatus of claim 38, wherein the staged heating protocol includes a schedule for heating the packaged food using the cooking apparatus.

40. The cooking apparatus of claim 38, wherein the controller is programmed to
determine the staged heating protocol for different food items based on information from a plurality of indicators, each associated with one of the food items,
determine the staged heating protocol based on user preference settings, and/or
determine a sous vide staged heating protocol with one or more target temperature for each package of food and/or heating periods for each package of food.

41.-43. (canceled)

44. The computer-implemented cooking method of claim 43, wherein the calculated cooking parameters include cooking times and/or cooking temperatures, and wherein the calculated cooking temperatures are sent, via a wireless network, for delivery to the cooking apparatus.

45. The computer-implemented cooking method of claim 43, wherein calculating the cooking parameters includes calculating one or more cooking times based on user data.

46. The computer-implemented cooking method of claim 43, further comprising:
receiving cooking data from the cooking apparatus; and
storing the cooking data in a data structure.

47. At least one tangible, non-transitory, computer-readable device, which has instructions that when executed by at least one data processing device, provides a computer-implemented cooking method.

48. A sous vide cooking system, comprising:
memory for storing recommended cooking parameters for cooking sous vide; and
a programmable processor with circuitry configured to execute instructions to cause the programmable processor to:
calculate cooking parameters based on the stored recommended cooking parameters, and
send the calculated cooking parameters for delivery to a cooking apparatus, wherein the cooking apparatus is configurable to cook the food based on the calculated cooking parameters to achieve a target doneness.

49.-52. (canceled)
